(19) United States
(12) Patent Application Publication
(10) Pub. No.: US 2012/0011395 A1
(43) Pub. Date: Jan. 12, 2012

(54) BOOT METHOD UNDER BOOT SECTOR FAILURE IN HARD DISK AND COMPUTER DEVICE USING THE SAME

(75) Inventors: Cheng-Zing Chou, Tainan County (TW); Yu-Chiang Cheng, Taipei City (TW)

(73) Assignee: GETAC TECHNOLOGY CORPORATION, HSINCHU (TW)

(21) Appl. No.: 12/833,871

(22) Filed: Jul. 9, 2010

(51) Int. Cl. G06F 11/16

(52) U.S. Cl. 714/6.13; 714/E11.062

(57) ABSTRACT

A boot method under a boot sector failure in a hard disk is provided, which includes the following steps. First, a detection unit is utilized to determine whether a boot sector in the hard disk fails. After determining that the boot sector fails, the detection unit utilizes a second boot file stored in a solid state disk (SSD) for booting. Meanwhile, the detection unit drives a pickup head in the hard disk to skip the failed boot sector and move to a normal sector in the hard disk, so as to boot a computer and enable the hard disk to operate normally.

### BACKGROUND OF THE INVENTION

1. Field of the Invention

The present invention relates to a boot method and a computer device using the same, and more particularly, to a boot method under a boot sector failure in a hard disk and a computer device using the same.

2. Related Art

Generally, due to being improperly used or dropped carelessly, a hard disk (HDD) of a current design usually suffers from damaged tracks, that is, a correct sector fails to be found among original sectors.

A damaged track in a hard disk includes a physical damage and a logical damage. The logical damage indicates a spurious damaged track, which is usually caused by improper software operation or improper usage. The logical damage may be repaired by using software. The physical damage indicates that damages have occurred in sectors of a disk in the hard disk, which can only be solved in a manner of avoiding damaged tracks by repartitioning disk sectors.

A damaged track in a hard disk may cause a damage and loss of system files or other important data stored in a computer. Thus, the present invention provides a boot method under a boot sector failure in a hard disk and a computer device using the same.

### SUMMARY OF THE INVENTION

Accordingly, in an embodiment, the present invention provides a boot method under a boot sector failure in a hard disk, which is suitable for a computer device. The method includes the following steps. A detection unit is utilized to detect whether a boot sector in a hard disk fails, in which a first boot file is stored in the boot sector. After determining that the boot sector fails, the detection unit drives a solid state disk (SSD) to provide a second boot file, and drives a pickup head in the hard disk to move to a normal sector in the hard disk. The normal sector and the boot sector are respectively disposed at different independent sectors in the hard disk. After the SSD provides the second boot file, the detection unit drives the computer device to execute the second boot file, thereby booting the computer device.

In an embodiment, the present invention provides a computer device, which includes a hard disk, an SSD, and a detection unit. The hard disk has a boot sector, a normal sector, and a pickup head. A first boot file is stored in the boot sector. The normal sector and the boot sector are different independent sectors in the hard disk. A second boot file is stored in the SSD. The detection unit determines whether the boot sector fails. After determining that the boot sector fails, the detection unit drives the SSD to provide the second boot file, and drives the pickup head to move to the normal sector. After the SSD provides the second boot file, the detection unit drives the computer device to execute the second boot file, thereby booting the computer device

### BRIEF DESCRIPTION OF THE DRAWINGS

The present invention will become more fully understood from the detailed description given herein below for illustration only, which thus is not limitative of the present invention, and wherein:

FIG. 1 is a schematic architectural view of a computer device according to an embodiment of the present invention.

FIG. 2 is a flowchart of a boot method under boot sector failure in a hard disk according to an embodiment of the present invention.

FIG. 3 is a schematic architectural view of a computer device according to another embodiment of the present invention.

### DETAILED DESCRIPTION OF THE INVENTION

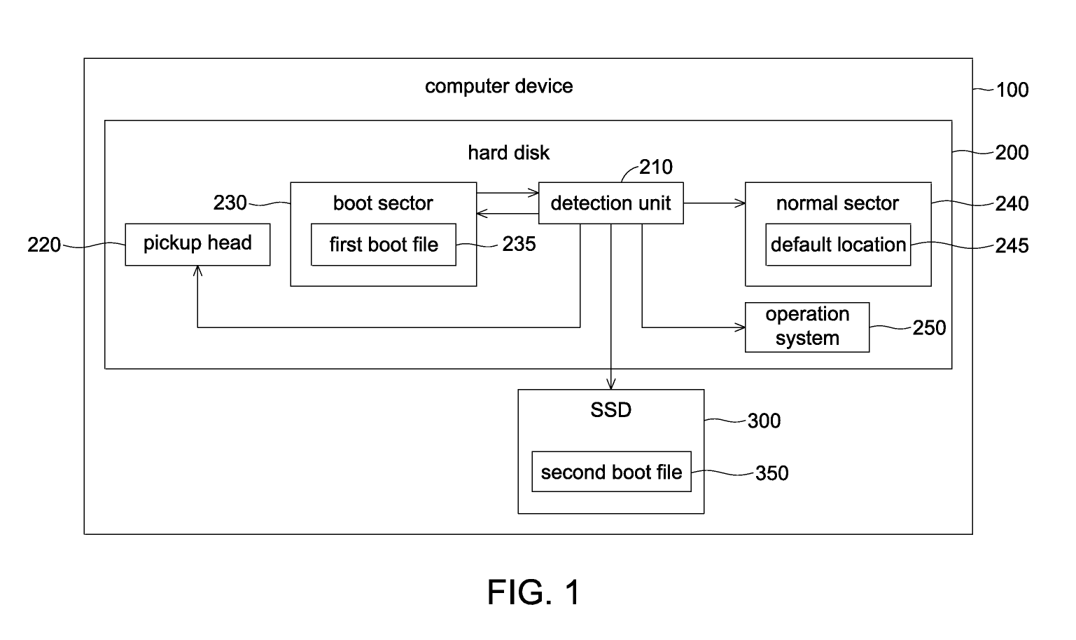

To make the objectives, features, and advantages of the present invention more comprehensible, preferred embodiments of the present invention are illustrated below in detail with reference to the accompanying drawings of FIGS. 1, 2, and 3. The specification of the present invention provides different embodiments to demonstrate technical features of different implementation manners of the present invention. The configuration of each element in the embodiments is only intended to illustrate the present invention, rather than limiting the present invention. The reference numerals in the drawings of the embodiments are partially repeated, which only aims at simplifying the illustration, instead of implying the correlations among different embodiments.

In an embodiment, the present invention provides a boot method under a boot sector failure in a hard disk and a computer device using the same.

In the boot method under a boot sector failure in a hard disk and the computer device using the same according to an embodiment of the present invention, an solid state disk (SSD) is integrated into a circuit in the hard disk, and the SSD enables a computer device to access a boot file to start an operating system of the computer device when an access problem occurs to a boot sector.

The SSD is mainly composed of an NAND flash, which is characterized by having no mechanical structures, so that circuit board damages or motor damages in a conventional hard disk never occur to the SSD. Thus, once the damage occurs, the data therein can be recovered by special technologies. In addition, the SSD employs the characteristics of a conventional NAND flash, so as to perform reading and writing operations in the manner of block writing and erasing. Compared with the current conventional hard disk, the SSD has advantages such as low electric power consumption, shock-proof, high reliability, and low temperature resistance.

FIG. 1 is a schematic architectural view of a computer device according to an embodiment of the present invention.

A computer device 100 according to an embodiment of the present invention at least includes a first storage device 200 and a second storage device 300. The first storage device 200 may be a hard disk, which includes a detection unit 210, a pickup head 220, a boot sector 230, a normal sector 240, and an operating system 250. A first boot file 235 is stored in the boot sector 230. The second storage device 300 may be an SSD, which includes a second boot file 350 for starting the operating system 250. The second boot file 350 stored in the second storage device 300 is a backup of the first boot file 235 stored in the second storage device 200. When the computer device 100 is started, the detection unit 210 drives the pickup head 220 to access the boot sector 230 in the hard disk 200. If the detection unit 210 finds out that the boot sector 230 is damaged and thus fails to access the first boot file 235. Then, the detection unit 210 drives the SSD 300 to provide the second boot file 350 in the SSD 300, and the detection unit 210 drives the computer device to execute the second boot file 350, so as to load the operating system 250 in the hard disk 200.

Meanwhile, a default location 245 is set in the normal sector 240. The default location usually refers to an initial (first) track in the normal sector 240. After determining that the boot sector fails, the detection unit 210 drives the pickup head 220 to move to the default location. Thus, when the computer device 100 is started, the detection unit 210 drives the pickup head 220 to skip the boot sector 230 in the hard disk 200 and to move to the default location. Meanwhile, the detection unit 210 drives the computer device to directly access the second boot file 350 in the SSD 300, so as to load the operating system 250 in the hard disk 200. It should be noted that, according to an embodiment of the present invention, the default location 245 refers to an initial (first) track in a normal sector, but the implementation of the present invention is not limited hereby.

In such a manner, even if a damaged track appears in the boot sector of the first storage device 200, the pickup head 220 skips the damaged track and the second boot file 350 in the second storage device 300 (SSD) is accessed directly to start the operating system 250.

It should be noted that, the detection unit 210 may be a control chip in the hard disk 200, an embedded controller (EC), or a microprocessor control unit (MCU).

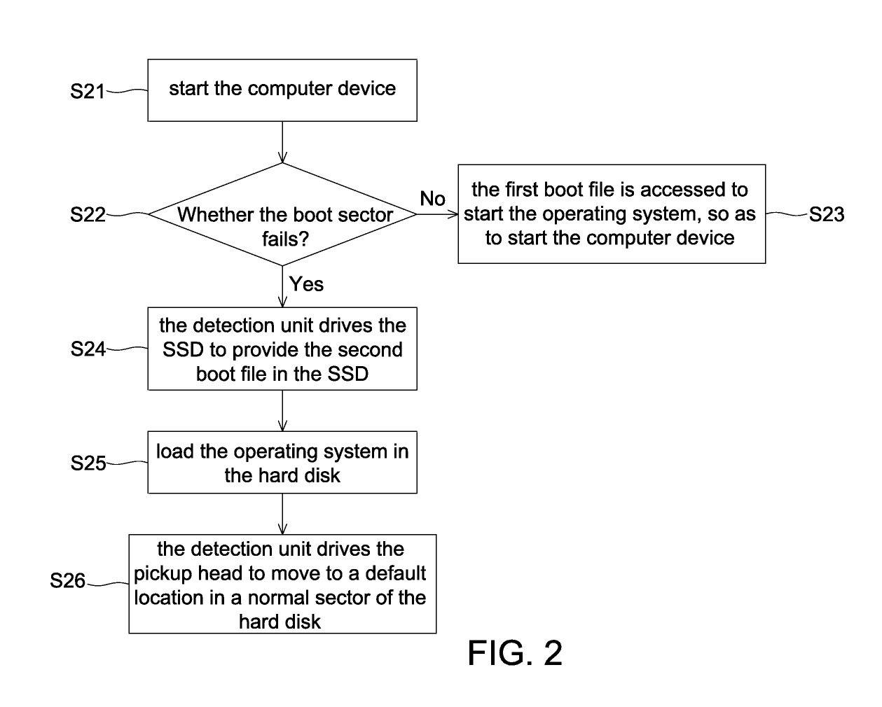

FIG. 2 is a flowchart of a boot method under boot sector failure in a hard disk according to an embodiment of the present invention.

The boot method under boot sector failure according to an embodiment of the present invention is suitable for a computer device, and the computer device at least includes a hard disk and an SSD. The hard disk includes a detection unit, a pickup head, a boot sector, a normal sector, and an operating system. A first boot file is stored in the boot sector. The SSD is mainly composed of Flash memory, and the SSD includes a second boot file used for starting the operating system in the hard disk, wherein the second boot file is a backup for the first boot file. When starting the computer device (Step S21), the detection unit drives the pickup head to access the boot sector in the hard disk, so as to determine whether the boot sector fails (Step S22).

If the boot sector does not fail, the first boot file is accessed to start the operating system, so as to start the computer device normally (Step S23). If the boot sector fails and the first boot file fails to be accessed, the detection unit drives the SSD to provide the second boot file in the SSD (Step S24), and the detection unit drives the computer device to execute the second boot file to load the operating system in the hard disk, thereby booting the computer device normally (Step S25).

Meanwhile, the detection unit drives the pickup head to move to a default location in a normal sector of the hard disk (Step S26). The normal sector and the boot sector are different independent sectors in the hard disk. The default location usually refers to an initial (first) track in the normal sector. Thus, when the computer device is started for the next time, the detection unit directly drives the SSD to provide the second boot file in the SSD and drives the computer device to execute the second boot file, so as to load the operating system in the hard disk, thereby starting the computer device normally.

In such a manner, the pickup head skips the damaged boot sector and move to other normal sectors in the hard disk to access data in the hard disk, so that other data in the hard disk can still be accessed normally. It should be noted that, according to an embodiment of the present invention, the default location refers to an initial (first) track in the normal sector, but the implementation of the present invention is not limited hereby.

It should be noted that, as the detection unit drives the pickup head to move to the normal sector, not only a boot failure resulted from the pickup head that reads the boot sector repeatedly due to the boot sector failure can be avoided, but also the time wasted in reading the boot sector repeatedly by the pickup head can be greatly decreased.

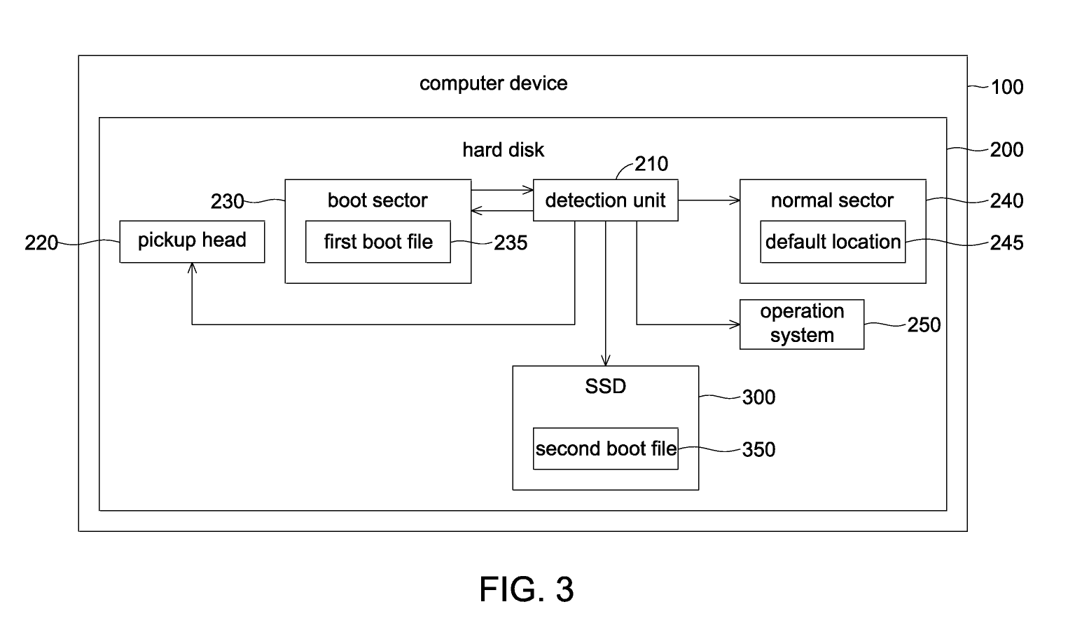

FIG. 3 is a schematic architectural view of a computer device according to another embodiment of the present invention.

In this embodiment, a second storage device 300 is built in a first storage device 200, and the implementation flow thereof is shown in FIG. 1, which will not be discussed here.

In a method for boot method under boot sector failure in a hard disk according to the embodiment of the present invention, an SSD (the second storage device 300) is integrated into a circuit in a hard disk (the first storage device 200), which enables an operating system of the computer device to be started when a track in the hard disk is damaged, thereby realizing the features of a thin configuration, light weight, low electric power consumption, and impact resistance.

The boot method of the present invention, or particular configurations or parts thereof may be embodied in the form of program codes. The program codes may be included in a physical medium such as a floppy disk, optical disk, hard disk, or any other machine-accessible (for example, computer-accessible) storage medium. When the program codes are loaded into and executed by a machine, e.g., a computer device, the machine becomes a device for implementing the present invention. The program codes may be transferred via certain transfer medium such as a wire or cable, optical fiber, or any other type of transfer medium. When the program codes are received, loaded into, and executed by a machine, e.g., a computer, the machine becomes a device for implementing the present invention. When the program codes are embodied in a general processing unit, the program codes together with the processing unit achieve a unique device, which is operated similar to an application specific logic circuit.

Although the present invention has been disclosed in the above preferred embodiments, the embodiments are not used to limit the present invention. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A boot method under a boot sector failure in a hard disk, suitable for a computer device, comprising the following steps of:
utilizing a detection unit to determine whether a boot sector in the hard disk fails, wherein a first boot file is stored in the boot sector;
after determining that the boot sector fails, driving a solid state disk (SSD) by the detection unit to provide a second boot file, and driving a pickup head in the hard disk by the detection unit to move to a normal sector in the hard disk, wherein the normal sector and the boot sector are different independent sectors in the hard disk; and
after the SSD provides the second boot file, driving the computer device by the detection unit to execute the second boot file, thereby booting the computer device

2. The boot method under a boot sector failure in a hard disk as claimed in claim 1, further comprising:
setting a default location in the normal sector; and
after determining that the boot sector fails, driving the pickup head by the detection unit to move to the default location.

3. The boot method under a boot sector failure in a hard disk as claimed in claim 1, wherein the SSD is built in the hard disk.

4. A computer device, comprising:
a hard disk, including a boot sector, a normal sector, and a pickup head, wherein a first boot file is stored in the boot sector, and the normal sector and the boot sector are different independent sectors in the hard disk;
a solid state disk (SSD), having a second boot file stored therein; and
a detection unit, for determine whether the boot sector fails, and driving the SSD to provide the second boot file, and driving the pickup head to move to the normal sector after determining that the boot sector fails, and further driving the computer device to execute the second boot file after the SSD provides the second boot file, thereby booting the computer device.

5. The computer device as claimed in claim 4, wherein a default location is set in the normal sector, and after the detection unit determines that the boot sector fails, the detection unit drives the pickup head to move to the default location.

6. The computer device as claimed in claim 4, wherein the SSD is built in the hard disk.

7. A computer recordable medium, suitable for storing a computer program, wherein the computer program comprises a plurality of program code segments for being loaded into a computer system and enabling the computer system to execute a boot method under a boot sector failure in a hard disk, wherein the method comprises:
utilizing a detection unit to determine whether a boot sector in the hard disk fails or not, wherein a first boot file is stored in the boot sector;
after determining that the boot sector fails, driving a solid state disk (SSD) by the detection unit to provide a second boot file, and driving a pickup head in the hard disk by the detection unit to move to a normal sector in the hard disk, wherein the normal sector and the boot sector are different independent sectors in the hard disk; and
after the SSD provides the second boot file, driving the computer device by the detection unit to execute the second boot file, thereby booting the computer device.

8. The computer recordable medium as claimed in claim 7, wherein the boot method further comprises:
setting a default location in the normal sector; and
after determining that the boot sector fails, driving the pickup head by the detection unit to move to the default location.
